(19) United States
(12) Patent Application Publication
(10) Pub. No.: US 2009/0196130 A1
(43) Pub. Date: Aug. 6, 2009

(54) INFORMATION RECORDING/REPRODUCING APPARATUS

(75) Inventors: Naoharu Yanagawa, Saitama (JP); Akira Shirota, Saitama (JP)

Correspondence Address: DRINKER BIDDLE & REATH (DC), 1500 K STREET, N.W., SUITE 1100, WASHINGTON, DC, 20005-1209, US

(73) Assignee: PIONEER CORPORATION, Tokyo (JP)

(21) Appl. No.: 12/065,535

(22) PCT Filed: Aug. 29, 2006
(86) PCT No.: PCT/JP2006/316993

§ 371 Date: Mar. 3, 2008

(30) Foreign Application Priority Data
Sep. 5, 2005 (JP) 2005-257060

(51) Int. Cl. G11B 7/085

(52) U.S. Cl. 369/30.22; G9B/7.042

(57) ABSTRACT

The present invention is directed to improve precision of tracking correction and focus correction while assuring stability of the tracking correction and focus correction during recording/reproducing of data to/from an optical disk.

Before start of recording/reproduction, an optical disk DK is searched once. On the basis of a radial acceleration component in a tracking error signal Ste, an area where a mechanical distortion occurs in the optical disk DK is specified. At the time of actually recording/reproducing data to/from the optical disk DK, the gain in a tracking servo circuit TS is temporarily improved only at the time of recording/reproducing data to/from the area specified as an area where a mechanical distortion or the like occurs. Also, even in the case where the gain is varied by performing optimum phase compensation on the gain set by using an optimum phase compensation by-gain circuit 23, reliable phase compensation is realized. Concerning the focus correction, also, gain compensation and phase compensation are performed using a method similar to that of the tracking correction.

### TECHNICAL FIELD

The present invention relates to an information recording/reproducing apparatus used for recording/reproducing information to/from an optical recording medium such as an optical disk.

### BACKGROUND ART

In an optical disk such as a CD (Compact Disc), a DVD (Digital Versatile Disc), or a BD (Blu-ray Disc) conventionally supplied to the market, in many cases, a partial mechanical distortion (for example, warp or thickness error of an optical disk substrate, distortion in a groove track, projections and depressions, radial runout, or the like) occurs due to manufacture conditions and the like. Since the mechanical distortion of this kind exerts a great influence on tracking correction and focus correction, it stands in the way of improving speed of recording/reproducing data to/from an optical disk.

A case is assumed such that, for example, a distortion in the disk radial direction occurs in an optical disk as shown in FIG. 1. Normally, radial acceleration which occurs at the time of recording/reproducing data to/from such an optical disk (strictly, radial acceleration which occurs due to the distortion) changes in proportion to the data recording/reproducing speed (linear velocity in CLV and angular velocity in CAV). As the recording/reproducing speed increases, the radial acceleration also increases. Consequently, at the time of recording/reproducing data at high speed (for example, 16×), a signal component corresponding to the mechanical distortion included in a tracking error signal shifts to a high frequency side as the radial acceleration increases, and it causes a situation that the frequency of the signal component exceeds a gain-crossover frequency of a servo system (that is, the frequency at which the gain in a circuit of the servo system becomes “0 dB”). As a result, the level of the signal component decreases in the tracking error signal fed back to the actuator, a tracking servo cannot trace a groove track, and the possibility of occurrence of a track skip becomes high.

In the case where a distortion in the direction perpendicular to the disk surface (for example, roughness existing in a groove track) exists, axial acceleration caused by the distortion changes in proportion to recording/reproducing speed. When the focus servo becomes unable to trace the distortion, a data read error occurs. Further, dirt or a scar existing in an optical disk also causes fluctuations in the radial acceleration and axial acceleration.

Therefore, to prevent occurrence of such a situation, it is necessary to improve the gain of the servo system to improve the gain-crossover frequency, and prevent the level of the signal component included in the tracking error signal from dropping.

On the other hand, in the case of improving the gain of the servo system, a phase margin in a circuit in the servo system is narrowed and the stability of the circuit becomes unable to be assured. It causes a situation that an error signal oscillates depending on a gain set value. To address the problem, a method is conventionally proposed in which a circuit for performing phase compensation (concretely, phase lag compensation and phase lead compensation) is provided or the servo system to assure stability of the circuit and improve the gain (for example, Patent Document 1).

Patent Document 1: Japanese Unexamined Patent Application Publication No. JP2001-176094

### DISCLOSURE OF THE INVENTION

### Problems to be Solved by the Invention

In the conventional information recording/reproducing apparatus, the gain of the servo system is set to a constant value, and only the function for realizing phase compensation optimum to the gain is realized. However, in the case of actually construing the apparatus, if the gain is always increased in the data recording/reproducing period, it causes deterioration in stability of the servo system. In addition, an actuator erroneously operates due to noise included in a light reception signal. It cannot be said that the method is desirable.

The present invention has been achieved in consideration of the above-described circumstances, and an object of the invention is to provide an information recording/reproducing apparatus realizing improvement in precision of tracking correction and focus correction while assuring stability of the tracking correction and the focus correction during recording/reproducing of data to/from an optical disk.

### Means for Solving the Problems

In order to solve the above problems, one aspect of the invention relates to an information recording/reproducing apparatus comprising:

an objective lens for condensing an outgoing beam from a light source onto a recording track provided in an optical recording medium;

light receiving means for receiving a reflection beam from the optical recording medium, of the outgoing beam, and outputting a light reception signal corresponding to the reflection beam;

error signal generating means for generating an error signal including at least one of a tracking error signal and a focus error signal on the basis of the light reception signal;

phase compensating means for performing phase compensation on the generated error signal; and

displacement means for displacing a disposing position of the objective lens in at least one of a radial axis direction of the recording track and a direction perpendicular to the surface of the optical recording medium on the basis of the error signal subjected to the phase compensation,

wherein the phase compensating means changes a phase difference to be given to the error signal during a period as a part of a period of recording/reproducing data to/from the optical recording medium.

### BRIEF DESCRIPTION OF THE DRAWINGS

FIG. 1 is a diagram showing a distortion in the radial direction occurring in an optical disk.

FIG. 2 is a block diagram showing the configuration of an information recording/reproducing apparatus RP in a first embodiment.

FIG. 3A is a diagram showing the waveform of a tracking error signal Ste when a tracking servo loop is open, FIG. 3B is a diagram showing the waveform of the tracking error signal Ste when the tracking servo loop is closed, and FIG. 3C is a diagram showing the waveform of a distortion detection signal Sdt.

FIG. 4 is a flowchart showing processes executed by a control unit C in the information recording/reproducing apparatus RP in the embodiment.

FIG. 5 is a block diagram showing the configuration of an information recording/reproducing apparatus RP2 in a second modification of the first embodiment.

FIG. 6 is a block diagram showing the configuration of an information recording/reproducing apparatus RP3 in a second embodiment.

### DESCRIPTION OF REFERENCE NUMERALS

RP, RP2, RP3 . . . information recording/reproducing apparatuses

TS, TS2, TS3 . . . tracking servo circuits

FS, FS2, FS3 . . . focus servo circuits

M . . . spindle motor

C . . . control unit

PU . . . optical pickup device

LD . . . laser driver circuit

P . . . playback unit

SP . . . signal processing unit

### BEST MODE FOR CARRYING OUT INVENTION

### 1 First Embodiment

### 1.1 Configuration of First Embodiment

### (1) General Configuration of Information

### Recording/Reproducing Apparatus

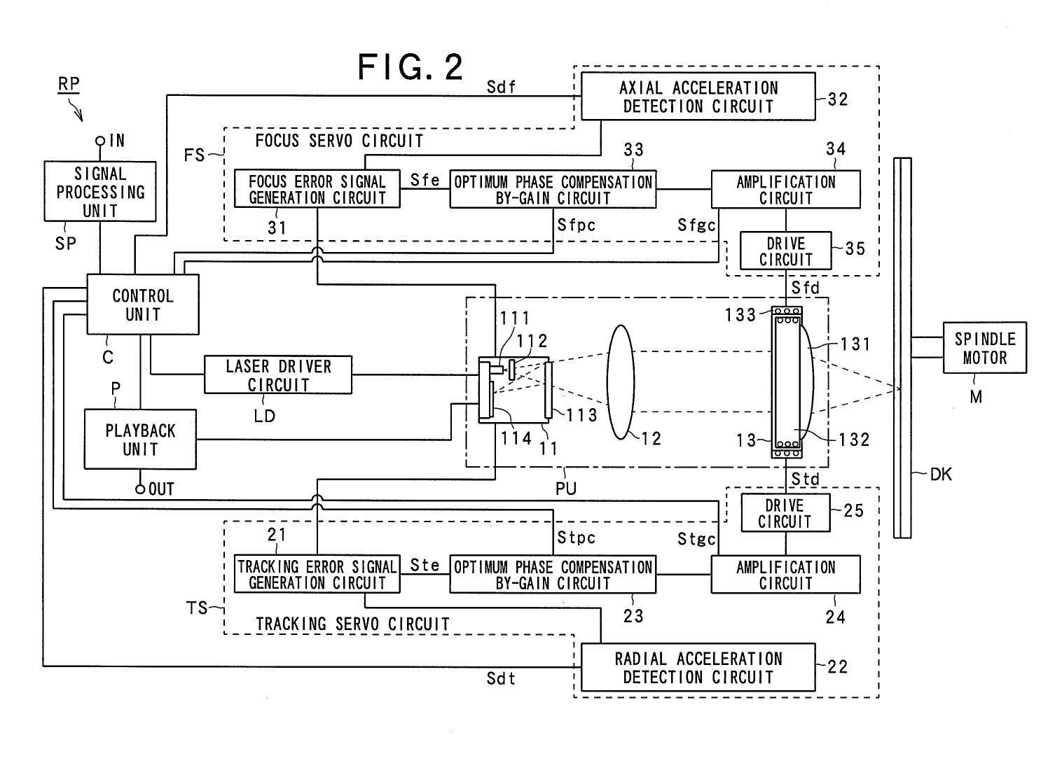

The configuration of an information recording/reproducing apparatus RP of a first embodiment of the present invention will be described with reference to FIG. 2. As shown in the diagram, the information recording/reproducing apparatus RP is roughly divided into a signal processing unit SP, a control unit C, a laser driver circuit LD, an optical pickup device PU, a playback unit P, a focus servo circuit FS, a tracking servo circuit TS, and a spindle motor M for rotating an optical disk DK clamped, and is used for recording/reproducing data to/from the optical disk DK.

As a characteristic matter of the embodiment, at the time of recording/reproducing data, the information recording/reproducing apparatus RP executes processes in the following two stages.

### Detecting Process (Pre-processing Stage)

This process is a process for searching the optical disk DK before recording or the like of data to the optical disk DK starts and detecting/controlling a mechanical distortion, scar, or dirt (hereinbelow, called “mechanical distortion or the like”) which occurs in the optical disk DK. As described above, radial acceleration and axial acceleration caused by the mechanical distortion or the like is detected as a high frequency component in the tracking error signal Ste and the focus error signal Sfe. In the embodiment, paying attention to the properties, a method is employed, of specifying an area in the optical disk DK, in which the radial acceleration and the axial acceleration becomes a predetermined value or larger on the basis of the high frequency components included in the tracking error signal Ste and the focus error signal Sfe and specifying an area in the optical disk DK, in which a mechanical distortion or the like occurs (hereinbelow, called “distortion occurrence area”). A table of addresses of the distortion occurrence areas specified by the method is formed to control and specify the distortion occurrence areas in the optical disk DK at the time of a recording/reproducing process which will be described below. In the case of actually generating the table, two tables for tracking servo and focus servo (hereinbelow, called a “tracking management table” and a “focus management table”) have to be generated. The process of generating the tables will be described in detail later.

### Recording/Reproducing Process

This process is a process for actually recording/reproducing data to/from the optical disk DK while adjusting the gain in the tracking servo circuit TS and the focus servo circuit FS on the basis of the two tables (specifically, the tracking management table and the focus management table) generated in the detecting process. More concretely, a distortion occurrence area is specified on the basis of the tables during recording/reproduction of data to/from the optical disk DK and the gain is temporarily improved only at the time of recording/reproducing data to/from the specified area (so-called gain compensation). By employing the method, the gain is temporarily improved at the time of recording/reproducing data to/from the distortion occurrence area while accruing stability of circuits of a servo system by decreasing the gain at the time of recording/reproducing data to/from a normal area, so that reliable tracking servo and focus servo can be realized.

On the other hand, there is a point to be noted at the time of performing such gain compensation. According to the gain set in the servo circuits TS and FS, a phase difference to be given at the time of performing phase compensation (hereinbelow, called “phase compensation amount”) varies. Consequently, in the case of switching the gain in the tracking servo circuit TS and the focus servo circuit FS between a distortion occurrence area and a normal area, there is the possibility that stability of the circuits cannot be assured without switching a phase compensation amount synchronously with the switching of the gain (concretely, the phase margin in the circuits TS and FS deteriorates as the gain improves). In the embodiment, therefore, the phase compensation amount is also switched between (i) at the time of recording/reproducing data to/from the distortion occurrence area and (ii) at the time of recording/reproducing data to/from the normal area.

At the time of recording/reproducing data to/from the distortion occurrence area, the gain to be set and the phase compensation amount may be changed for each of optical disks DK or may be constant values. Since the individual difference exists among the optical disks DK to/from which data is recorded/reproduced, in the embodiment, description will be given on assumption that a table is generated in the detecting process, after that, the gain and the phase compensation amount optimum to the optical disk DK are calculated, and the recording/reproducing process is executed on the basis of the calculated gain and the like.

A concrete configuration of the information recording/reproducing apparatus RP in the embodiment for realizing the functions will be described below.

First, the signal processing unit SP has an input terminal, performs a signal process of a predetermined format on data input from the outside via the terminal, and outputs the processed data to the control unit C.

The laser driver circuit LD is constructed mainly by an amplification circuit, amplifies a drive signal input from the control unit C and, after that, supplies the amplified signal to the optical pickup device PU. The amplification factor in the laser driver circuit LD is controlled by the control unit C. At the time of recording data to the optical disk DK, the amplification factor is controlled so that a light beam is output at a recording power (an energy amount at which a phase change or pigment change occurs in the optical disk DK of a pigment change type or a phase change type). On the other hand, at the time of reproducing data, the amplification factor is controlled so that a light beam is output at a reproduction power (an energy amount at which a pigment change or the like does not occur).

The optical pickup device PU is an element for irradiating the optical disk DK with a light beam on the basis of a control signal supplied from the laser driver circuit LD to record/reproduce data to/from the optical disk DK. The optical pickup device PU has a hologram laser unit 11, a collimator lens 12, and an actuator 13.

The hologram laser unit 11 is a light source unit in which a semiconductor laser 111 and an OEIC 114 are packed in a package. The semiconductor laser 111 and the OEIC 114 are disposed on the same substrate. On the optical path of outgoing light from the semiconductor laser 111, a grating 112 for diffracting the outgoing light into a main beam (zeroth-order beam) and two sub-beams (±primary beams) is provided. The main beam and the sub beams diffracted by the grating 112 are incident on a hologram device 113.

The hologram device 113 transmits the main beam and the sub beams incident from the grating 112 and guides the beams to the collimator lens 12. On the other hand, the hologram device 113 gives astigmatism to at least a part of reflection light from the collimator lens 12 (concretely, reflection light from the surface of the optical disk DK of the main beam and the sub beams) and guides the resultant light to the OEIC 114. By the function of the hologram device 113, light is separated to an outgoing path (that is, the direction of guiding the outgoing light from the semiconductor laser 111 to the optical disk DK) and a return path (that is, the direction of guiding the reflection light to the OEIC 114).

The OEIC 114 has three light reception areas for receiving the reflection light of the main beam and the sub beams. (i) The light reception area for reflection light of the main beam is divided in four parts. (ii) The light reception area for reflection light of each of the sub beams is divided in two parts.

The actuator 13 has an objective lens 131, an objective lens holder 132 for fixing the objective lens 131 and, further, a movable mechanism 133 for integrally moving the objective lens holder 132. The actuator 13 makes the position of the objective lens 131 displace on the basis of a tracking drive signal Std supplied from the tracking servo circuit TS and a focus drive signal Sfd supplied from the focus servo circuit FS to realize tracking servo and focus servo.

The playback unit P has, for example, an addition circuit and an amplification circuit and generates a reproduction RF signal on the basis of a light reception signal supplied from the OEIC 114. The playback unit P supplies the reproduction RF signal to the control unit C, performs a predetermined signal process on the reproduction RF signal, and outputs the processed signal to an output terminal OUT.

The tracking servo circuit TS and the focus servo circuit FS are elements for driving the actuator on the basis of the light reception signal supplied from the OEIC 114 and realizing tracking servo or focus servo. Any tracking correction method may be employed in the tracking servo circuit TS and any focus correcting method maybe employed in the focus servo circuit FS. For example, as the tracking correction method, the heterodyne method or the 3-beam method typified by the DPD method can be used. As the focus correcting method, for example, the spot size method can be employed. The embodiment will be described on assumption that, for embodying the apparatus, the DPP (Differential Push-Pull) method is employed as the tracking correction method, and the astigmatism method is employed as the focus correcting method.

The control unit C is constructed mainly by a CPU (Central Processing Unit) and controls the components of the information recording/reproducing apparatus RP. For example, in the case of recording data to the optical disk DK, the control unit C outputs a recording drive signal corresponding to data input from the signal processing unit SP to the laser driver circuit LD. On the other hand, in the case of reproducing data recorded on the optical disk DK, the control unit C outputs a reproduction drive signal to the laser driver circuit LD. The control unit C generates a tracking management table and a focus management table for specifying a distortion occurrence area on the basis of signals supplied from the tracking servo circuit TS and the focus servo circuit FS (that is, executes the above-described detecting process). The control unit C controls switching of the gain and the phase compensation amount in the tracking servo circuit TS and the focus servo circuit FS on the basis of the generated two tables.

### (2) Concrete Configuration of Servo Circuits TS and FS

The concrete configuration of each of the tracking servo circuit TS and the focus servo circuit FS will now be described.

### (2-1) Tracking Servo Circuit TS

First, the tracking servo circuit TS will be described. The tracking servo circuit TS has a tracking error signal generation circuit 21, a radial acceleration detection circuit 22, an optimum phase compensation by-gain circuit 23, an amplification circuit 24, and a drive circuit 25.

The tracking error signal generation circuit 21 as one of the elements generates a tracking error signal Ste (concretely, a DPP signal) on the basis of the light reception signal supplied from the OEIC 114. The method of generating the tracking error signal Ste by the tracking error signal generation circuit 21 is similar to that in the conventional information recording/reproducing apparatus employing the DPP method as the tracking correction method.

The radial acceleration detection circuit 22 is an element for specifying the distortion occurrence area in the above-described detecting process, generates a distortion detection signal Sdt indicative of the distortion occurrence area on the basis of the tracking error signal Ste supplied from the tracking error signal generation circuit 21 and supplies it to the control unit C.

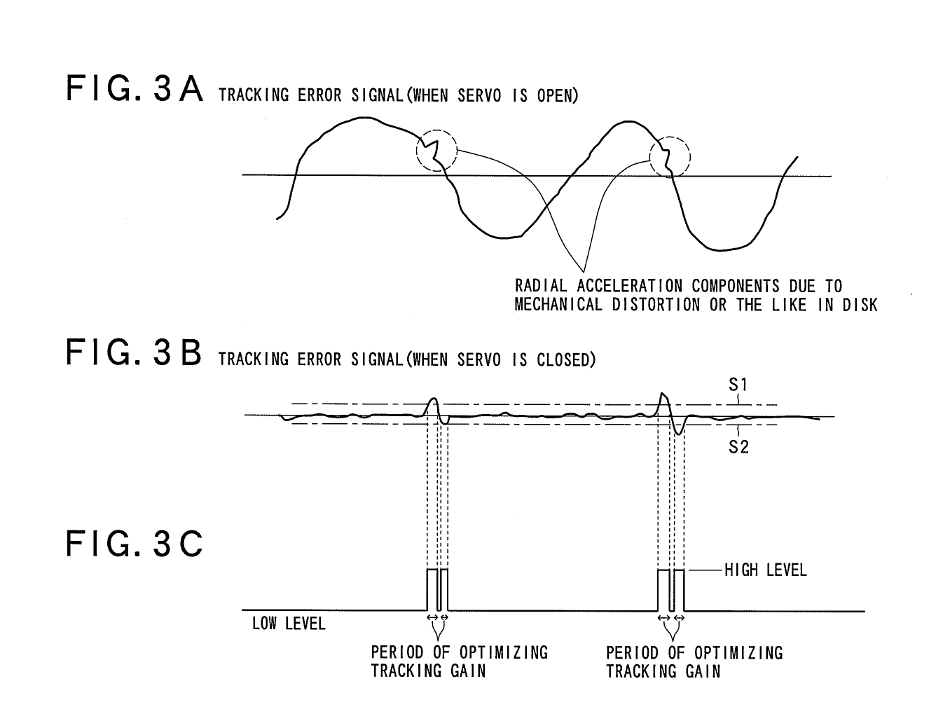

A method of generating the distortion occurrence area detection signal Sdt in the radial acceleration detection circuit 22 and a method of generating the tracking management table by the control unit C on the basis of the distortion occurrence area detection signal Sdt will be described with reference to FIGS. 3A to 3C. FIG. 3A shows the waveform of the tracking error signal Ste when the tracking servo loop is open. FIG. 3B shows the waveform of the tracking error signal Ste when the tracking servo loop is closed. FIG. 3C shows the waveform of the distortion detection signal Sdt.

First, when a track search is performed in the state where the servo loop is open, as shown in FIG. 3A, a radial acceleration component caused by a mechanical distortion or the like is added to the tracking error signal Ste having an almost sine wave. After that, when the tracking servo loop is closed for the detecting process, the actuator 13 is driven so that the tracking error signal Ste becomes “0”. During search of a normal area (including the case where even when a mechanical distortion or the like occurs, the actuator 13 can trace the distortion or the like), the tracking error signal Ste can be always maintained at around “0”. In this state, for example, when a distortion in the radial direction having a large displacement amount exists in the optical disk DK and the radial acceleration component caused by the distortion exceeds the gain-crossover frequency of the tracking servo circuit TS, the actuator 13 cannot trace the distortion, and the radial acceleration component appears as a high-frequency component in the tracking error signal Ste. In the embodiment, the distortion detection signal Sdt supplied to the control unit C is held at the “H” level during the period in which the high-frequency component is detected (at the “L” level during the period corresponding to the normal area), so that the distortion occurrence area can be specified properly.

In practice, an arbitrary method is used as the method of specifying the distortion occurrence area. For example, any of the following methods can be employed.

### Method 1

In this method, the amplitude level of the tacking error signal Ste obtained when the tracking servo loop is closed is compared with predetermined thresholds S1 and S2 and an interval in which the amplitude level exceeds the thresholds is detected as the distortion occurrence area. Normally, a radial acceleration component in the tracking error signal Ste after the servo loop is closed is obtained as an S-shaped signal. Consequently, it is sufficient to compare the tracking error signal Ste with the two different thresholds S1 and S2 by a comparator and, when the amplitude level exceeds the thresholds S1 and S2, set the distortion detection signal Sdt to the “H” level. It can be realized by, for example, a method similar to that of Japanese Unexamined Patent Application Publication No. 2004-62945.

### Method 2

In this method, the frequency of the tacking error signal Ste obtained after the tracking servo loop is closed is compared with a predetermined threshold in the detecting process, and an interval in which the frequency exceeds the threshold is detected as the distortion occurrence area. In the case of employing the method, for example, it is sufficient to provide the radial acceleration detection circuit 22 with a high-pass filter, detect whether a signal component equal to or higher than predetermined frequency is included in a tracking error signal or not, and maintain the distortion detection signal Sdt to the “H” level in the period in which the component is detected. It is also possible to perform frequency conversion (Fourier transformation) on the tracking error signal Ste in the radial acceleration detection circuit 22 and maintain the distortion detection signal Sdt to the “H” level in the period where the frequency at which the level is the highest exceeds a predetermined threshold (frequency).

On the other hand, when the distortion detection signal Sdt is supplied from the radial acceleration detection circuit 22 by the above process, the control unit C generates the tracking management table on the basis of the distortion detection signal Sdt. At this time, the control unit C always monitors a reproduction RF signal supplied from the playback unit P and obtains the address of an area corresponding to the period in which the distortion detection signal Sdt is at the “H” level. The obtained address is stored in the tracking management table, and at the time of the recording/reproducing process, an area in which the gain and the phase compensation amount are to be switched is specified.

Next, the optimum phase compensation by-gain circuit 23 is constructed by, for example, a DSP (Digital Signal Processor). At the time of the recording/reproducing process, digital process is performed on the tracking error signal Ste supplied from the tracking error signal generation circuit 21 to perform the phase compensation on the tracking error signal Ste. The phase compensation amount in the optimum phase compensation by-gain circuit 23 can be switched on the basis of a phase control signal Stpc supplied from the control unit C. The control unit C outputs the phase control signal Stpc on the basis of the tracking management table, thereby switching between the phase compensation amount at the time of recording/reproducing data to/from an area corresponding to the address stored in the tracking management table (that is, the distortion occurrence area) and the phase compensation amount at the time of recording/reproducing data to/from the other area (that is, the normal area).

The amplification circuit 24 amplifies the tracking error signal Ste supplied from the optimum phase compensation by-gain circuit 23 by a predetermined gain and supplies the amplified signal to the drive circuit 25. The gain in the amplification circuit 24 can be switched by a gain control signal Stgc supplied from the control unit C. The control unit C specifies a period in which the gain is to be improved on the basis of the address stored in the tracking management table, and improves the gain of the amplification circuit 24 only in the period.

As a result, in the tracking servo circuit TS, switching of the gain and the phase compensation amount is realized at the time of executing the recording/reproducing process.

### (2-2) Focus Servo Circuit FS

Next, the focus servo circuit FS will be described. The focus servo circuit FS has a focus error signal generation circuit 31, an axial acceleration detection circuit 32, an optimum phase compensation by-gain circuit 33, an amplification circuit 34, and a drive circuit 35.

The focus error signal generation circuit 31 as one of the elements generates a focus error signal Sfe on the basis of the light reception signal supplied from the OEIC 114 and supplies it to the axial acceleration detection circuit 32 and the optimum phase compensation by-gain circuit 33. The method of generating the focus error signal Sfe in the focus error signal generation circuit 31 is similar to that in the conventional information recording/reproducing apparatus employing the astigmatism method.

The axial acceleration detection circuit 32 is an element for specifying the distortion occurrence area in the detecting process, generates a distortion detection signal Sdf indicative of the distortion occurrence area on the basis of the focus error signal Sfe supplied from the focus error signal generation circuit 31 and supplies it to the control unit C. As a result, in the control unit C, a focus management table is generated, and an area in which the gain and the phase compensation amount are switched at the time of the recording/reproducing process is specified. The method of specifying the distortion occurrence area and generating the distortion detection signal Sdf in the axial acceleration detection circuit 32 and the method of generating the focus management table in the control unit C are similar to those in the processes performed at the time of generating the tracking management table.

The optimum phase compensation by-gain circuit 33 is constructed by, for example, a DSP and is an element for performing a predetermined amount of phase compensation on the focus error signal Sfe. The amplification circuit 34 is an element for amplifying the focus error signal Sfe supplied from the optimum phase compensation by-gain circuit 33 with a predetermined gain and supplying the amplified signal to the drive circuit 35. The phase compensation amount and the gain in the circuits 33 and 34 are switched on the basis of the phase control signal Sfpc and the gain control signal Sfgc supplied from the control unit C. The control unit C monitors the focus management table and generates the phase control signal Sfpc and the gain control signal Sfgc. The process is executed concurrently with the process of generating the phase control signal Stpc and the gain control signal Stgc for tracking correction.

### [1.2] Operation of First Embodiment

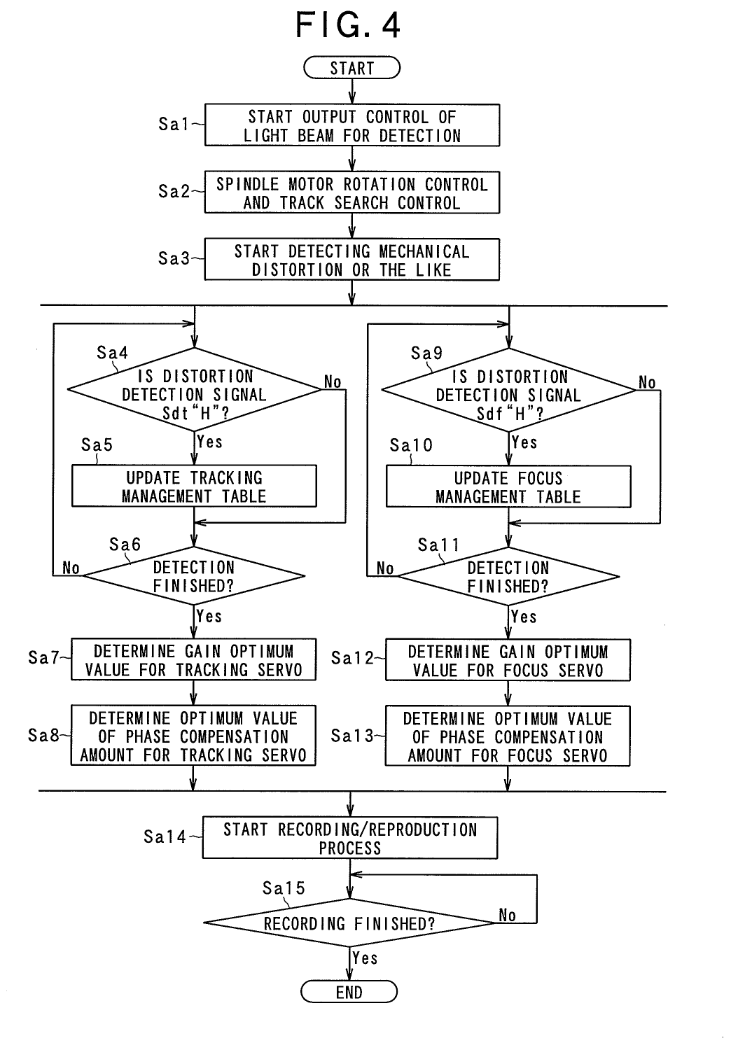

The operations performed at the time of recording/reproducing data to/from the optical disk DK in the information recording/reproducing layer RP in the embodiment will be described with reference to FIG. 4. FIG. 4 is a flowchart showing the processes executed by the control unit C at the time of recording/reproducing data to/from the optical disk DK.

When the user sets the optical disk DK in the information recording/reproducing apparatus RP and performs a predetermined input operation (for example, an input operation of recording data), the control unit C starts supplying a drive signal for the detecting process to the laser driver circuit LD (step Sa1). As a result, a light beam emitted from the semiconductor laser 111 is diffracted by the grating 112 into three beams. The three beams pass through the hologram device 113 and the collimator lens 12 and are condensed by the objective lens 131 onto the surface of the optical disk DK. In such a manner, the main beam and the sub beams condensed on the surface of the optical disk DK are reflected by the surface of the optical disk DK. The reflected beams pass through the objective lens 131 and the collimator lens 12 and are incident on the hologram device 113. The beams are subject to predetermined astigmatism in the hologram device 113 and, after that, the resultant beams are condensed in the light reception area provided in the OEIC 114. As a result, a light reception signal at a level corresponding to the light reception amount of reflection light is generated in the OEIC 114. The light reception signal is supplied to each of the playback unit P, the tracking servo circuit TS, and the focus servo circuit FS.

When the light reception signal is output from the OEIC 114, the control unit C executes a process for performing rotation control of the spindle motor M and a track search (step Sa2). On completion of the track search, the tracking servo loop is closed and detection of a mechanical distortion starts (step Sa3). The control unit C shifts to a state where the following two processes (that is, “a process of generating the tracking management table” and “a process of generating the focus management table”) are executed in parallel (steps Sa4 to Sa8 and steps Sa9 to Sa13).

### Tracking Management Table Generating Process

First, in step Sa1, when the semiconductor laser 111 is driven and a light reception signal is generated in the OEIC 114 on the basis of reflection light from the surface of the optical disk DK, the tracking servo circuit TS generates the tracking error signal Ste on the basis of the light reception signal, and the distortion detection signal Sdt is output by the radial acceleration detection circuit 22 on the basis of the tracking error signal Ste.

In the process, first, the control unit C monitors the distortion detection signal Sdt and determines whether the signal level of the distortion detection signal Sdt is the “H” level or not (step Sa4). When it is determined as “No”, the normal area in the optical disk DK is irradiated with the light beam. Consequently, the control unit C shifts to a state of determining whether detection of a mechanical distortion or the like has been completed or not without executing the process in the step Sa5 (step Sa6).

On the other hand, when it is determined as “Yes” in step Sa4, the distortion occurrence area in the optical disk DK (for example, an area in which distortion in the radial direction of the optical disk DK occurs in a groove track or the like) is irradiated with a light beam. Consequently, the control unit C updates the tracking management table (step Sa5) and shifts to a state where the determination of step Sa6 is made. At this time, the control unit C specifies unit data (for example, sector) including a present search area on the basis of the reproduction RF signal generated by the playback unit P and stores the specified address to the tracking management table.

The process is repeated until all of searches on areas to which data is recorded/reproduced completes. When it is determined as “Yes” in the step Sa6 on completion of the search, the control unit C determines the optimum value of the gain for tracking correction (step Sa7). After that, the control unit C determines the optimum value of the phase compensation amount for tracking correction (step Sa8), and shifts to the process in step Sa14.

The concrete method used at the time of determining the optimum value of the gain in step Sa7 is arbitrary, and it is sufficient to set so that the noise component in FIG. 3B becomes flat with the optimum value of the servo. As a concrete method, for example, the following method can be employed. First, some samples (concretely, addresses) are determined from the tracking management table, and the search position is jumped to the addresses corresponding to the samples. Whether the envelope of the reproduction RF signal corresponding to the area lies in a predetermined range (for example, a range including an error of ±15 percent) or not is determined. The gain may be set so that the envelope lies in the predetermined range.

As another method, it is also possible to obtain an eye pattern from a light reception signal corresponding to the area of a sample picked up from the tracking management table, obtain a jitter on the basis of a degradation state of the eye pattern, and set the gain so that the jitter amount lies in a permissible range (for example, a range including a detection error of about 8 to 9 percent). Further, as another method, the gain may be determined on the basis of the number of errors (that is, error rate) at the time of reproducing data and the modulation degree of a reproduction RF signal.

The method of determining the optimum value of the phase compensation amount in the step Sa8 is also arbitrary. For example, it is also possible to experimentally obtain the optimum phase compensation amount according to the value of the gain, make a table defining the gain and the phase compensation amount held in the control unit C, and determine the phase compensation amount on the basis of the table and the gain set in step Sa7.

### Focus Management Table Generating Process

A focus management table generating process will now be described. In the process, first, the control unit C monitors the distortion detection signal Sdf generated by the axial acceleration detection circuit 32 and determines whether the signal level of the distortion detection signal Sdf is the “H” level or not (step Sa9). When it is determined as “No”, the optical disk DK is in a state where a distortion in the light beam irradiation direction (for example, roughness or the like in a groove track) does not occur (that is, in the normal area), the control unit C shifts to a state of determining whether detection of a mechanical distortion or the like has been completed or not without executing the process in the step Sa10 (step Sa11).

On the other hand, when it is determined as “Yes” in step Sa9, a distortion in the light beam irradiation direction occurs in the optical disk DK (that is, the distortion occurrence area), the control unit C specifies an address corresponding to an area being presently searched on the basis of the reproduction RF signal, stores the specified address to the focus management table, thereby updating the focus management table (step Sa10) and performs the determining process in step Sa11. The process is repeated until all of searches on areas to which data is recorded/reproduced completes. On completion of the search, the determination in step Sa11 changes to “Yes”, and the control unit C determines the optimum value of the gain for focus correction (step Sa12). After that, the control unit C determines the optimum value of the phase compensation amount for focus correction (step Sa13), and shifts to the process in step Sa14. A concrete process executed at this time is arbitrary. For example, a method similar to that used at the time of determining a gain and a phase compensation amount for the tracking correction can be employed.

When the tracking management table generating process and the focus management table generating process are completed and the process shifts to step Sa14, the control unit C starts the recording/reproducing process. First, the control unit C executes the following processes according to recording/reproduction of data to/from the optical disk DK.

### <Reproducing Process>

At the time of reproduction, the control unit C supplies a data reproduction control signal to the laser driver circuit LD, and controls the output power of the laser driver circuit LD so that a light beam for reproduction is output.

### <Recording Process>

At the time of recording, the control unit C supplies a drive signal corresponding data to be recorded to the laser driver circuit LD on the basis of a signal supplied from the signal processing unit SP, and controls the output power of the laser driver circuit LD to the recording power.

When recording/reproduction of data starts in such a manner, the control unit C generates the gain control signal Stgc and the phase control signal Stpc in accordance with the tracking management table and the gain and the phase compensation amount determined in the steps Sa7 and Sa8, and supplies the signals to the amplification circuit 24 and the optimum phase compensation by-gain circuit 23.

At this time, the control unit C generates the gain control signal Sfgc and the phase control signal Sfpc in accordance with the focus management table and the gain and the phase compensation amount determined in the steps Sa12 and Sa13, and supplies the signals to the amplification circuit 34 and the optimum phase compensation by-gain circuit 33. As a result, only at the time of recording/reproducing data to/from the distortion occurrence area, the gain is switched in the tracking servo circuit TS and the focus servo circuit FS, the phase compensation amount is switched, and the actuator can follow the mechanical distortion or the like which occurs in the optical disk DK.

A concrete process in this case is arbitrary. For example, it is possible to expect a timing of recording/reproducing data to/from a sector corresponding to an address stored in the tracking management table and the focus management table on the basis of the reproduction RF signal and switch the gain and the shift compensation amount during the period of recording data to the sector.

As described above, the information recording/reproducing apparatus RP in the embodiment switches the phase compensation amount given to the tracking error signal Ste and the focus error signal Sfe during a period as a part of the period of recording data to the optical disk DK or the period of reproducing data from the optical disk DK (concretely, a period corresponding to the distortion occurrence area). Therefore, the phase compensation amount can be adjusted with the switch of the gain. While assuring stability of the tracking correction and focus correction during recording/reproduction of data to/from an optical disk, the precision of the tracking correction and the focus correction can be improved.

In addition, the information recording/reproducing apparatus RP of the embodiment varies the phase compensation amount synchronously with the gain switch timing, so that the stability in the circuits of the servo system can be further assured.

Further, the information recording/reproducing apparatus RP of the embodiment performs the detecting process before start of recording/reproduction of data to/from the optical disk DK, detects whether the high frequency components in the tracking error signal Ste and the focus error signal Sfe exceed the thresholds S1 and S2 or not, generates the tracking management table and the focus management table, and changes the phase compensation amount on the basis of the tables. Consequently, a mechanical distortion or the like which occurs in the optical disk DK can be properly detected, and the phase compensation amount can be switched according to the detection result. Thus, the precision of the tracking correction and the focus correction can be improved, and occurrence of a track skip, a reproduction error, or the like can be effectively prevented.

In the embodiment, the configuration of storing addresses in the tracking management table and the focus management table is employed. It is also possible to store the position in the radial direction and the rotation angle on the optical disk DK of the distortion occurrence area in place of the addresses, and switch the gain and the phase compensation amount in accordance with the position in the radial direction and the rotation angle.

In the foregoing embodiment, the case where the DPP method is employed as the tracking correction method and the astigmatism method is employed as the focus correction method has been described as an example. Alternately, as the tracking correction method, the heterodyne method or the 3-beam method typified by the DPD method can be used. As the focus correcting method, for example, the spot size method can be employed. It is to be noted that the division form of the OEIC 114 and the circuit configuration of the tracking error signal generation circuit 21 and the focus error signal generation circuit 31 have to be properly changed.

Further, in the embodiment, the configuration of constructing the optimum phase compensation by-gain circuits 23 and 33 by digital circuits such as DSPs and realizing the phase compensation by digital process is employed. Another configuration may be employed such that a plurality of phase lead compensation circuits and a plurality of phase lag compensation circuits with different phase compensation amounts are provided in each of the optimum phase compensation by-gain circuits 23 and 33 to perform analog phase compensation.

### 1.3 Modifications of First Embodiment

### (1) First Modification

In the first embodiment, regardless of the speed of recording/reproducing data to/from the optical disk DK, all of areas to/from which data is to be recorded/reproduced are searched, the tracking management table and the focus management table are generated, and the gain and the phase compensation amount are switched uniformly. However, in the case of the information recording/reproducing apparatus RP having the function of switching recording speed, while low recording/reproducing speed (for example, 4× or 8×) is set, the actuator can trace a mechanical distortion or the like which occurs in the optical disk DK. It is therefore unnecessary to perform the detecting process in advance and switch the gain and the like at the timing of recording data to the distortion occurrence area.

(a) For example, in the case of the information recording/reproducing apparatus RP employing the method of switching the recording speed in accordance with a position in the radial direction in the optical disk DK such as 4× for an area on the inner radius side of the optical disk DK (an area of about 30 mm from the center of the optical disk DK), 8× for an intermediate area (30 to 50 mm), and 16× for an area on the outer radius side (50 to 60 mm), it is sufficient to perform the detecting process and switch the gain and the like only in the case of recording/reproducing data to the area on the outer radius side. It is unnecessary to perform such a process on the area on the inner radius side to the intermediate area.

(b) In the case of a DVD recorder whose recording/reproducing speed can be optionally switched by the user, it is sufficient to execute the process only in the case where the recording/reproducing speed selected by the user is high speed.

In the information recording/reproducing apparatus RP of the modification, the recording/reproducing speed which is set at the time of recording/reproducing information is detected and, only in the case where the set recording/reproducing speed exceeds predetermined speed, the detecting process and the switching of the gain and the like are performed. At the time of low-speed and intermediate-speed recording, the detecting process is not performed. By employing such a method, the detecting process can be omitted at the time of low-speed and intermediate-speed recording and reproduction, so that higher-speed processing can be realized.

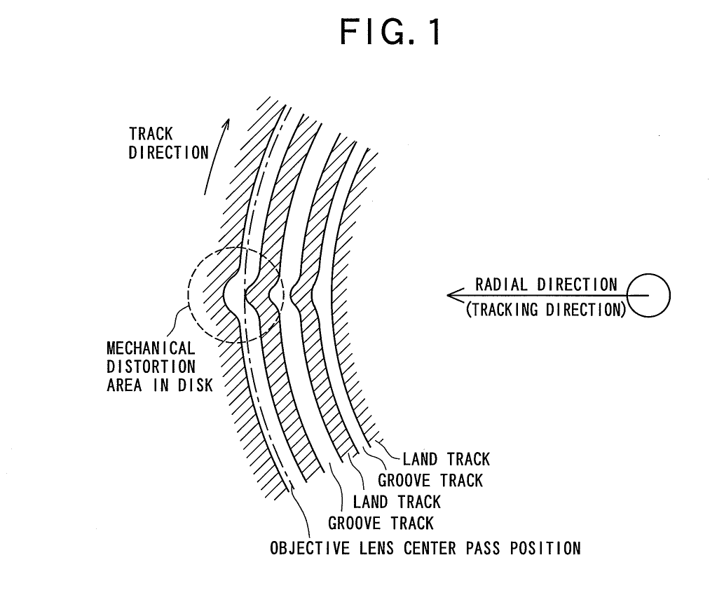

In this case as well, the configuration of the apparatus RP is similar to that of FIG. 1. As the process executed in the apparatus RP, (i) in the case of executing the detecting process, it is sufficient to execute processes similar to those of FIG. 4. (ii) In the case where the detecting process is not executed, it is sufficient to execute processes similar to those of a conventional DVD recorder or the like.

In the case where the low and intermediate recording/reproducing speeds are set in the modification, the gain and the phase compensation amount are maintained constant during recording/reproduction of data. The gain and the phase compensation amount in this case may be the same as or different from those at the time of recording/reproducing data to the normal area in high-speed recording. In the case of employing the CAV (Constant Angular Velocity) method in the information recording/reproducing apparatus RP or the method of switching the recording/reproducing speed in accordance with a position in the radial direction, if the phase compensation amount is changed according to a change in the recording/reproducing speed, there is the possibility that data cannot be recorded/reproduced at high speed. Therefore, in this case, it is desirable to make the phase compensation amount which is set in the low-speed and intermediate-speed recording/reproduction and that set at the time of recording/reproducing data to/from a normal area at the time of high-speed recording the same.

### (2) Second Modification

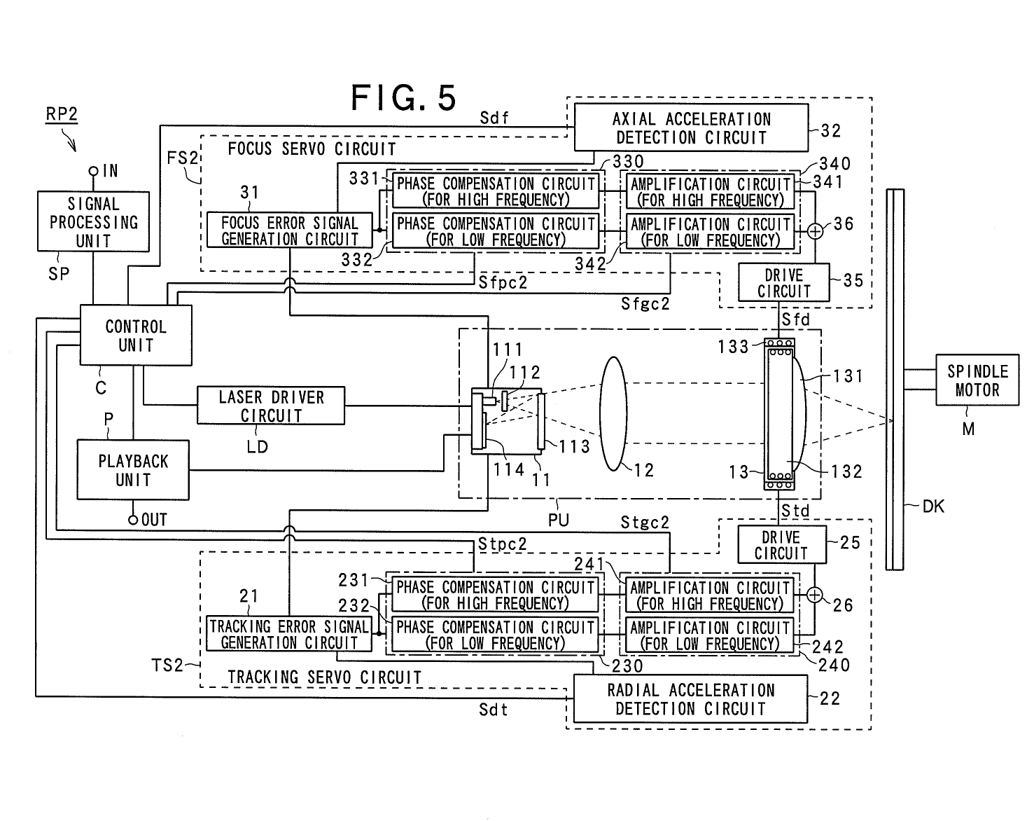

FIG. 5 is a block diagram showing the configuration of an information recording/reproducing apparatus RP2 in a second modification. In FIG. 5, likewise reference numerals are designated to elements similar to those of FIG. 2.

The information recording/reproducing apparatus RP of the first embodiment employs the configuration of uniformly performing the gain compensation and the phase compensation on the tracking error signal Ste and the focus error signal Sfe generated in the tracking error signal generation circuit 21 and the focus error signal generation circuit 31, respectively.

However, in the case of actually performing the gain compensation and the phase compensation on the tracking error signal Ste and the focus error signal Sfe, the possibility that the optimum gain and the optimum phase compensation amount become different from each other between the high-frequency band components and the low-frequency band components in the error signals Ste and Sfe is high. For example, with respect to the high-frequency band components, to properly detect the radial acceleration component and the axial acceleration component, it is necessary to increase the gain and set the gain-crossover frequency to high frequency. On the other hand, with respect to the low-frequency band components, it is unnecessary to set the gain to be large. It is rather necessary to set the gain in a proper range from the viewpoint of assuring stability of the circuit. As the gain set value varies, naturally, the optimum phase compensation amount also changes.

In the information recording/reproducing apparatus RP2 of the modification, from the above-described viewpoint, each of the tracking error signal Ste and the focus error signal Sfe is separated to a high-frequency band component and a low-frequency band component, and the gain compensation and the phase compensation are performed for each of the frequency band components. The apparatus employs the method realizing both reliable gain compensation and phase compensation and improvement in stability in the circuits of the servo system by adding the frequency band components after the compensation and driving the actuator 13.

To realize such functions, in the embodiment, an optimum phase compensation by-gain circuit 230 (330 in the focus servo circuit FS2, in the following, the numerals in parentheses refer to the elements in the focus servo circuit FS2) has therein a phase compensation circuit 231 (331) for high frequency and a phase compensation circuit 232 (332) for low frequency. The phase compensation circuit 231 (331) for high frequency is provided with a high-pass filter, and the phase compensation circuit 232 (332) for low frequency is provided with a low-pass filter. As a result, the high-frequency band component included in the tracking error signal Ste supplied from the tracking error signal generation circuit 21 is input to the phase compensation circuit 231 for high frequency, and the low-frequency band component is input to the phase compensation circuit 232 for low frequency. The phase compensation circuits 231 (331) and 232 (332) are controlled on the basis of a phase control signal Stpc2 (Sfpc2) supplied from the control unit C.

In the information recording/reproducing apparatus RP2 of the modification, the amplification circuit 240 (340) is also provided with an amplification circuit 241 (341) for high frequency and an amplification circuit 242 (342) for low frequency. On the basis of again control signal Stgc2 (Sfgc2) supplied from the control unit C, the amplification circuits 240 and 241 amplify an output signal from the phase compensation circuit 231 (331) for high frequency and an output signal from the phase compensation circuit 232 (332) for low frequency, respectively, by a predetermined gain. Output signals from the amplification circuits 241 (341) and 242 (342) are supplied to an adder 26 (36) and added. After that, the resultant signal is supplied to the drive circuit 25 (35).

In the case of employing the method, attention is paid to the point that the gain and the phase compensation amount for high-frequency band components and the gain and the phase compensation amount for low-frequency band components have to be determined at the time of determining the gain and the phase compensation amount in the steps Sa7 and Sa8 (steps Sa12 and Sa13) in FIG. 4. Processes at the time of recording/reproducing data to/from a normal area are similar to those of the first embodiment.

As described above, the information recording/reproducing apparatus RP2 in the modification has the configuration of dividing each of the tracking error signal Ste and the focus error signal Sfe to a high-frequency band component and a low-frequency band component and perform the gain compensation and the phase compensation for each of the frequency band components. Thus, while realizing reliable gain compensation and phase compensation, stability in the circuits of the servo system can be improved.

### 2. Second Embodiment

### 2.1 Configuration and Operation of Second Embodiment

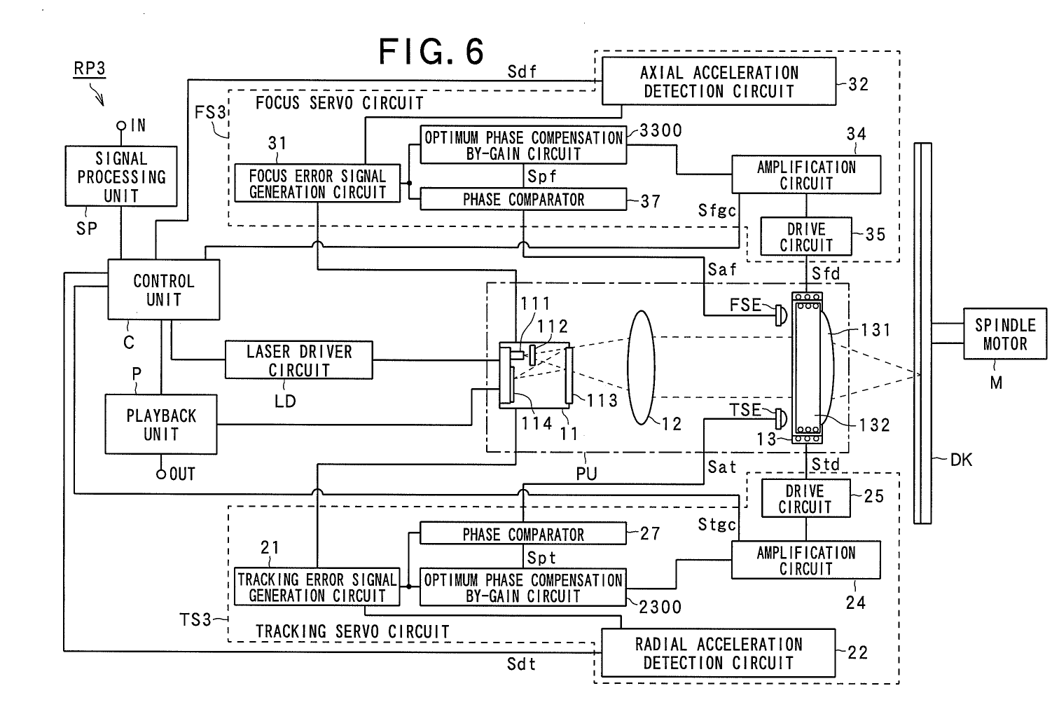

FIG. 6 is a block diagram showing the configuration of an information recording/reproducing apparatus RP3 in a second embodiment. In FIG. 6, likewise reference numerals are designated to elements similar to those of FIG. 2.

In the first embodiment, the method of executing the detecting process before start of actual recording/reproduction and determining the phase compensation amount on the basis of a gain which is set in the process is employed. The information recording/reproducing apparatus RP3 in the second embodiment employs the method described below.

The optical pickup device PU has therein a tracking sensor TSE and a focus sensor FSE for detecting the displacement amount of the objective lens 131 in the actuator 13 and outputting displacement amount detection signals Sat and Saf corresponding to the displacement amount. Phase comparators 27 and 37 compare (a) the phases of the displacement amount detection signals Sat and Saf output from the tracking sensor TSE and the focus sensor FSE with (b) the phases of the tracking error signal Ste and the focus error signal Sfe.

In the case where the actuator 13 is properly driven on the basis of the tracking error signal Ste and the focus error signal Sfe, the displacement amount detection signals Sat and Saf and the tracking error signal Ste and the focus error signal Sfe have the same phase. On the other hand, when the actuator 13 is not properly driven on the basis of the tracking error signal Ste and the focus error signal Sfe, a phase difference occurs between the displacement amount detection signals Sat and Saf and the tracking error signal Ste and the focus error signal Sfe.

In the information recording/reproducing apparatus RP3 of the embodiment, attention is paid to the relation, and phase difference signals Spt and Spf each indicative of a detected phase difference are supplied from the phase comparators 27 and 37 to optimum phase compensation by-gain circuits 2300 and 3300, respectively. On the basis of the phase difference signals Spt and Spf, the phase compensation amounts in the phase compensation circuits 2300 and 3300 are switched.

Any formats may be used for the phase difference signals Spt and Spf. The voltage values of the signals may be changed according to a phase difference occurred.

An arbitrary method may be used for determining the phase compensation amount in the optimum phase compensation by-gain circuits 2300 and 3300 on the basis of the phase difference signals Spt and Spf. For example, the phase compensation amount corresponding to each of the phase differences is experimentally obtained and a table storing the experiment value is stored in the optimum phase compensation by-gain circuits 2300 and 3300. The phase compensation amount may be switched on the basis of the table and the values of the phase difference signals Spt and Spf supplied from the phase comparators 27 and 37.

Since the gain compensating method is similar to that in the first embodiment, the detailed description will not be repeated.

As described above, the information recording/reproducing apparatus RP3 in the embodiment employs the method of determining the phase compensation amount in the optimum phase compensation by-gain circuits 2300 and 3300 on the basis of the phase difference between the displacement amount detection signals Sat and Saf each indicative of the displacement amount of the objective lens 131 and the tracking error signal Ste and the focus error signal Sfe. Consequently, the timing of switching the phase compensation amount can be determined on the basis of the actual displacement state of the objective lens 131, so that the precision of tracking correction and focus correction can be improved. In the configuration, the absolute amount of the phase difference can be specified by comparing the phases of the signals, so that phase compensation is facilitated.

### 2.2 Modifications of Second Embodiment

### (1) First Modification

The second embodiment employs the method of providing the tracking sensor TSE and the focus sensor FSE for detecting the displacement amount of the objective lens 131, and determining the phase compensation amount on the basis of the displacement amount detection signals Sat and Saf obtained in the sensors TSE and FSE. It is also possible to actually feed back the drive signals Std and Sfd supplied to the actuator 13 to the phase comparators 27 and 37, compare the phases of the drive signals Std and Sfd with those of tracking error signal Ste and the focus error signal Sfe and, according to the comparison result, switch the phase compensation amount. In this case as well, the other configuration is similar to that of the second embodiment, so that the detailed description will not be repeated.

### (2) Second Modification

The information recording/reproducing apparatus RP3 in the second embodiment employs the configuration including the radial acceleration detection circuit 22 and the axial acceleration detection circuit 32, generating the tracking management table and the focus management table on the basis of the tracking error signal Ste and the focus error signal Sfe, and switching the gain. Alternatively, the gain switching timing may be also determined on the basis of the displacement amount detection signals Sat and Saf in the tracking sensor TSE and the focus sensor FSE. In this case, it is unnecessary to execute the detecting process in advance. It is sufficient to supply the phase difference signals Spt and Spf output from the phase comparator 37 to the amplification circuits 24 and 34 and, on the basis of the phase difference signals Spt and Spf, switch the gain in a real-time manner.

It is arbitrary how to determine the gain set value in this case. A gain to be set is obtained by experiment in accordance with the values of the phase difference signals Spt and Spf, and a table storing the experiment value may be held in the amplification circuits 24 and 34.

The present invention is not limited to the foregoing embodiments. The embodiments are illustrative and have the configuration substantially the same as that of the technical ideas described in the scope of claims of the invention. Any arrangement producing similar effects are within the technical scope of the present invention.

All of disclosures in the Japanese Patent Application (No. 2005-257060) including the specification, the scope of claims, the drawings, and the abstract filed on Sep. 5, 2005 are hereby incorporated by reference into this application.

1. An information recording/reproducing apparatus comprising:
an objective lens for condensing an outgoing beam from a light source onto a recording track provided in an optical recording medium;
a light receiving device which receives a reflection beam from the optical recording medium, of the outgoing beam, and outputs a light reception signal corresponding to the reflection beam;
an error signal generating device which generates an error signal including at least one of a tracking error signal and a focus error signal on the basis of the light reception signal;
a phase compensating device which performs phase compensation on the generated error signal; and
a displacement device which displaces a disposing position of the objective lens in at least one of a radial axis direction of the recording track and a direction perpendicular to the surface of the optical recording medium on the basis of the error signal subjected to the phase compensation,
wherein the phase compensating device changes a phase difference to be given to the error signal during a period as a part of a period of recording/reproducing data to/from the optical recording medium, and divides the error signal into a plurality of bands in accordance with frequency, and gives a phase difference which varies according to the frequency bands.

2. The information recording/reproducing apparatus according to claim 1,
further comprising an amplifying device which amplifies the error signal to improve gain in the period as a part of the period of recording/reproducing data to/from the optical recording medium.

3. The information recording/reproducing apparatus according to claim 2,
wherein the phase compensating device changes a phase difference synchronously with the period in which the amplifying device improves the gain.

4. The information recording/reproducing apparatus according to claim 1, further comprising:
a detecting device which detects whether or not a high frequency component in the generated error signal exceeds a predetermined threshold before start of recording or reproducing of data to/from the optical recording medium; and
a specifying device, when the detecting device detects that the high frequency component exceeds the threshold, which specifies an area on the optical recording medium corresponding to the period during which the high frequency component exceeds the threshold,
wherein the phase compensating device changes the phase difference during the period of recording/reproducing data to/from the area specified by the specifying device.

5. The information recording/reproducing apparatus according to claim 1,
further comprising a recording/reproducing speed setting device which sets a speed of recording/reproducing data to/from the optical recording medium,
wherein the phase compensating means device changes the phase difference in accordance with the speed which is set by the recording/reproducing speed setting device.

6. (canceled)

7. (canceled)

8. (canceled)

9. (canceled)
